(19) United States
(12) Patent Application Publication
(10) Pub. No.: US 2018/0032487 A1
(43) Pub. Date: Feb. 1, 2018

(54) SCALABLE VECTOR GRAPHICS BUNDLES

(71) Applicant: Microsoft Technology Licensing, LLC, Redmond, WA (US)

(72) Inventors: Lucas Stanford, Sammamish, WA (US); Madhur Joshi, Kirkland, WA (US); William Moy, Seattle, WA (US); Andrew Philip Birck, Seattle, WA (US)

(21) Appl. No.: 15/221,518

(22) Filed: Jul. 27, 2016

(51) Int. Cl. G06F 17/22; G06F 17/24; G06F 17/21

(52) U.S. Cl. CPC G06F 17/2247; G06F 17/211; G06F 17/24

(57) ABSTRACT

An SVG system for creating an SVG bundle of svg elements that adhere to a theme is provided. The SVG system accesses svg elements that are to be included in the bundle and accesses theme attributes of the theme. For each svg element, the SVG system retrieves the svg element, establishes a name for the svg element, modifies the svg element to use values for the theme attributes as specified by the theme, and stores the svg element and the established name in an SVG bundle. To use the SVG bundle, a web page includes a specification of values for theme attributes and a reference to an svg element. When the web page is rendered, the svg element is inserted into the web page at the location of the reference and is processed based on values of the theme attributes to generate a graphic for the web page.

### BACKGROUND

Scalable Vector Graphics (“SVG”) is a language for describing a two-dimensional graphic (e.g., logo or symbol). SVG specifies the elements and attributes that can be used to describe a graphic using the eXtensible Markup Language (“XML”). SVG supports the describing of three types of graphic objects: vector graphic shapes, images, and text. A vector graphic shape is a path of one or more lines such as a line, a path of lines, a circle, a rectangle, or an arbitrary polygon. SVG supports the setting of various attributes of graphic objects such as font style, stroke width, stroke pattern, stroke color, fill color, filter effect, and so on.

The primary element of SVG is the svg element, which includes other elements and attributes. The other elements are used for rendering shapes such as a circle, rectangle, ellipse, path, and so on, and for rendering images and text. The attributes of the svg element specify the height and width (e.g., in pixels) of the graphic, the point that corresponds to the origin (which defaults to the upper-left corner), and so on. The coordinates of a graphic are specified relative to the origin. The attributes for the various shapes are specific to the shape. For example, attributes for a circle specify the center of the circle and the radius of the circle, and attributes for a rectangle specify the left and the top position of the rectangle within the graphic and the height and width of the rectangle. Other attributes can be used for different types of shapes. For example, attributes for both a rectangle and a circle specify stroke width, stroke color, fill color, and so on. The following is an example of an svg element defining a graphic that includes a circle within a square.

### Example 1

<svg width=“400” height=“180”>

<rect

x=“50” y=“20”
width=“150” height=“150”
style=“fill:yellow;stroke:pink;stroke-width:5;fill-opacity:0.1” />

<circle r=“75” cx=“125” cy=“95” fill=“green” />

</svg>

In the open svg tag of the svg element, the width and the height attributes specify that the graphic is 400 by 180. In the rect element, the width and height attributes specify that the rectangle is 150 by 150 in size, the x and y attributes specify that the rectangle is positioned at location (50, 20), and the style attribute specifies various attributes of the rectangle such as fill color and fill opacity. In the circle element, the r attribute specifies the radius as 75, the cx and cy attributes specify that the center of the circle is at location (125, 75), and the fill attribute specifies the fill color for the circle.

Because SVG allows graphics to be described that range from very simple to very complex, SVG is a very popular choice for describing graphics in web pages, which are described in HyperText Markup Language (“HTML”) documents. A web page may include many graphics such as for representing complex symbols, company logos, animations, and so on, which are described using SVG. Rather than creating an svg element for a complex graphic, a developer may use an svg element developed by another. For example, an SVG developer may develop svg elements for a wide range of popular graphics and make them available to web page developers. A web page developer can either include an svg element in the web page or include a reference to the svg element in the web page. The web page developer, however, may need to modify the svg element to match the theme of the web page. For example, the svg element for a complex symbol may specify a fill color of red, which may not fit into the theme of a web page that is based on the color blue. It can take a considerable amount of effort to modify svg elements to ensure that they are consistent with the theme of a web page.

### SUMMARY

An SVG system for creating an SVG bundle of SVG definitions (e.g., svg elements) that adhere to a theme is provided. The SVG system accesses SVG definitions that are to be included in the bundle and accesses theme attributes of the theme. For each SVG definition, the SVG system retrieves the SVG definition. The SVG system also establishes a name for the SVG definition. The SVG system modifies the SVG definition to use values for the theme attributes as specified by the theme. The SVG system stores the SVG definition and the established name in an SVG bundle. The SVG system may also add an initialize function to the SVG bundle.

To use the SVG bundle, a web page includes a specification of values for theme attributes of the theme (and typically also values for non-theme attributes) and a reference to an SVG definition in the SVG bundle. When the web page is rendered, the initialize function specified by the SVG bundle is executed. For each SVG definition, the initialize function generates a function for inserting that SVG definition into the web page at a location of a reference to the SVG definition. When the reference to the SVG definition in the web page is encountered, the generated function for the SVG definition is executed to insert the SVG definition at the location of the reference to the SVG definition. The SVG definition is processed based on values of the theme attributes to generate a graphic for the web page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of an SVG system in some embodiments.

FIG. 2 is a flow diagram that illustrates the processing of a create bundle component of the SVG system in some embodiments.

FIG. 3 is a flow diagram that illustrates the processing of a modify element component of the SVG system in some embodiments.

FIG. 4 is a flow diagram that illustrates the processing of an initialize function of the SVG system in some embodiments.

### DETAILED DESCRIPTION

A method and system for bundling scalable vector graphics elements to ensure adherence to a theme is provided. A theme specifies attributes of an SVG description (e.g., svg element) whose values are to be provided outside the SVG description. For example, a web page that includes an svg element may have a style element that provides values for the theme attributes of the theme of the web page. The svg element is rendered using the values for the theme attributes specified by the style element. If the same svg element is included in a different web page, the svg element will be rendered using the values for the theme attributes specified by the style element of that web page.

In some embodiments, an SVG system creates an SVG bundle (e.g., file) of SVG descriptions that adhere to a theme. An SVG description “adheres” to a theme when it is adapted to use values for theme attributes that are specified outside the SVG description. For example, if an svg element adheres to a theme that specifies a fill attribute, then when the svg element is rendered, the theme is applied to the svg element by taking the value for the fill attribute, for example, from a style element that provides a value for the fill attribute. The use of the values specified for the theme attributes when rendering the graphic of an SVG description is referred to as “applying” the theme to the SVG description. The SVG descriptions may be developed to adhere to the theme or may be existing SVG descriptions that have been modified to adhere to the theme. To create an SVG bundle, the SVG system accesses SVG descriptions of graphics to be included in the SVG bundle. For example, each SVG description may be previously specified using the svg element of HTML. The SVG system also accesses theme attributes, which are attributes for the descriptions that are to be specified by a theme. For example, the theme attributes may be those attributes whose values are specified by a style element HTML that is based on Cascading Style Sheets (“CSS”). A theme specifies values for attributes that are to be used by the SVG descriptions. For example, a theme may specify a certain font and a certain fill color by specifying a certain value (e.g., Arial) for a font attribute and a certain value (e.g., blue) for a color attribute. The SVG system modifies the SVG descriptions so that when they are included in a document, they adhere to the theme of the document. For example, if an svg element includes a font attribute or a color attribute, the SVG system may remove those attributes from the svg element so that the svg element inherits those attributes from the style element that specifies the theme. The SVG system also establishes a name for each SVG description. For example, if each svg element is in a separate file, the SVG system may use the name of the file (e.g., “AcmeLogo.svg”) as the name of the svg element. The SVG system then stores the modified SVG descriptions and their names in an SVG bundle, which may be a single file. For example, an SVG bundle may include each of the svg elements and an index that maps the names of the svg elements to their locations within the bundle.

In some embodiments, the SVG system may also add to an SVG bundle an initialize function that generates an SVG function for each SVG description within the SVG bundle. The name of the SVG function for an SVG description may be based on the name of the SVG description. When a document (e.g., web page) includes a graphic described by an SVG description of an SVG bundle, the document may include an invocation of the SVG function for the SVG description. When the document is rendered, the initialize function is executed to generate the SVG functions and to register them with the rendering engine. Each SVG function inserts its corresponding SVG description in the document at the location of invocation. The rendering engine then renders the graphic described by the SVG description.

In some embodiments, an SVG bundle may be stored at an SVG server that serves SVG bundles to clients when rendering a document that references an SVG description of an SVG bundle to describe a graphic. When a client renders a document that references an SVG description in an SVG bundle, the client requests the SVG server to provide the SVG bundle. The rendering engine may invoke the initialize function and the SVG function to insert the SVG description in the document as described above. When the rendering engine renders the graphic of an SVG description, the rendering engine uses the values for attributes as specified by the theme unless the SVG description overrides a value by including a value for that attribute in the SVG description.

The following is an example of a style element that specifies a theme that applies to and svg element.

### Example 2

<style>

svg {fill:red; stroke:yellow; stroke-width:5; fill-opacity:0.1}

</style>

The svg before the brackets is a selector that indicates a theme that is specific to the svg element, and the attributes within the brackets specify the theme. The following example illustrates a modification to the svg element of Example 1 to adhere to the theme.

### Example 3

<svg width=“400” height=“180”>

<rect

x=“50” y=“20”
width=“150” height=“150” />

<circle r=“75” cx=“125” cy=“95” fill=“green” fill-opacity:1.0/>

</svg>

The style attribute from the rect element has been removed and a fill-opacity attribute has been added to the circle element. When the graphic is rendered, the rectangle will be rendered using the attributes of the theme. The circle will also be rendered using the attributes of the theme except that the circle element overrides the fill attribute and the fill-opacity attribute of the theme.

In some embodiments, a theme for an svg element may include sub-themes, and the svg elements of an SVG bundle may specify the sub-themes that apply to it. For example, a theme may specify that certain values for attributes are to be used for some types of graphics (e.g., mathematical symbols) and other values are to be used by different types of graphics (e.g., polygons). The sub-themes may be specified using classes for the selectors of a style element. The following is an example of such selectors.

### Example 4

<style>

svg.poly {stoke:red};
svg.symbol {stroke:yellow}

</style>

The following illustrates a modification to Example 3 that uses the poly sub-theme.

### Example 5

<svg class=“poly” width=“400” height=“180”>

<rect

x=“50” y=“20”
width=“150” height=“150” />

<circle r=“75” cx=“125” cy=“95” fill=“green” fill-opacity:1.0
stroke=“black”/>

</svg>

In this example, the rectangle will be rendered with a red stroke. However, the circle will be rendered with a black stroke because it overrides the stroke color of the svg.poly class.

The SVG system solves several technical problems encountered when using svg elements. First, the SVG system allows the svg elements in an SVG bundle to adhere to a theme. In this way, whenever an svg element from an SVG bundle is rendered with the values for the theme attributes specified, the svg element is rendered based on those values. Second, when a web page includes references to several different svg elements, a rendering engine would need to request each svg element in a separate request. With an SVG bundle, svg elements that are commonly used together can be included in the same bundle so that only a single request is needed to retrieve all the svg elements.

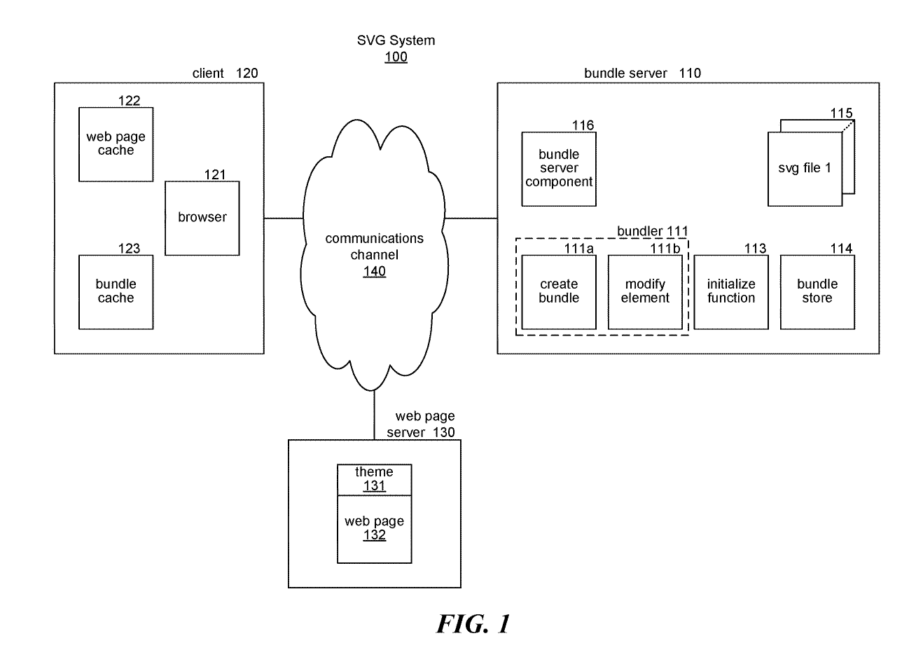

FIG. 1 is a block diagram that illustrates components of an SVG system in some embodiments. The SVG system 100 includes a bundle server 110, a client 120, and a web page server 130 that communicate via a communications channel 140. The bundle server includes a bundler component 111 (that includes a create bundle component 111a and a modify element component 111b, an initialize function 113, a bundle store 114, SVG files 115, and a bundle server component 116. The create bundle component of the bundler component inputs the SVG files and a description of a theme. The create bundle component invokes the modify element component of the bundler component to modify the svg elements within the SVG files to adhere to the theme. The create bundle component then stores the modified svg elements and the initialize function into a bundle and stores the bundle in the bundle store. The initialize function is invoked when rendering a web page that references an svg element within the bundle to create functions for the svg elements of the bundle. The bundle server component receives requests from clients for svg elements and returns the bundle that contains the requested svg element to the client. The bundle server may also include an index that maps svg elements to the bundles in which they are stored. The client includes a browser 121, a web page cache 122, and a bundle cache 123. The browser retrieves from the web page server web pages that include references to svg elements stored in a bundle. The browser stores the retrieved web pages in the web page cache. The browser also retrieves the bundle (or bundles) containing the svg elements of a web page from the bundle server, which may be part of the web page server. The browser stores the bundle in the bundle cache. The browser then invokes the rendering engine to render the web page. When rendering the web page, the rendering engine invokes the initialize function of the bundle to create a function for each svg element of the bundle. When the rendering engine encounters a reference to a function for an svg element within the web page, the rendering engine invokes the function to insert the svg element into the web page. The rendering engine then processes the svg element to render the graphic described by the svg element using values of the theme attributes specified by the theme of the web page. The web page server includes a web page 131 that includes a theme 132 that specifies values for the attributes of the theme.

In some embodiments, the components of the SVG system may be arranged in different ways. For example, web page server may include the bundle server and the bundle store. In such a case, the web page server also functions as a bundle server that serves SVG bundles from the bundle store to clients. As another example, the creation of the SVG bundles may be performed by a computing system that is separate from the bundle server and the web page server. In such a case, a separate computing system may include the create bundle component, the modify element component, and the initialize function component and the SVG files and generate a bundle. The computing system can then provide the bundle to the bundle server for serving to clients.

The computing systems on which the SVG system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include servers of a data center, massively parallel systems, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have data recorded on them or may be encoded with computer-executable instructions or logic that implements the SVG system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting deployment data using the keys.

The SVG system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the SVG system may be implemented in hardware using, for example, an application-specific integrated circuit (ASIC).

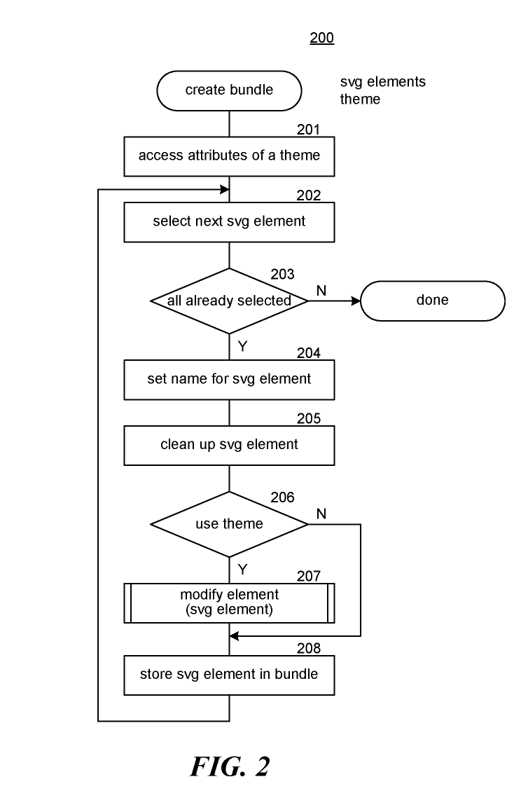

FIG. 2 is a flow diagram that illustrates the processing of a create bundle component of the SVG system in some embodiments. A create bundle component 200 is passed an indication of svg elements and a theme and generates an SVG bundle that contains the svg elements modified to adhere to the theme. In block 201, the component accesses attributes of the theme, which are referred to as theme attributes. In blocks 202-208, the component loops adding each svg element to the bundle. In block 202, the component selects the next svg element. In decision block 203, if all the svg elements have already been selected, then the component completes, else the component continues at block 204. In block 204, the component sets the name for the selected svg element. For example, the name may be set to the file name of the file that contains the svg element. In block 205, the component cleans up the svg element. The cleanup processing may include removing unwanted content such as comments, authorship information, and other information from each svg element. The cleanup processing may also include ensuring that the formatting (e.g., spacing and capitalization) of the svg elements is consistent. In decision block 206, if the svg element is to adhere to the theme, the component continues at block 207, else the component continues at block 208. An svg element may not adhere to the theme, for example, if the svg element describes a company logo, a flag, and so on whose colors are invariant. In block 207, the component invokes the modify element component passing an indication of the selected svg element to modify the svg element to adhere to the theme. In block 208, the component stores the svg element in the bundle and then loops to block 202 to select the next svg element.

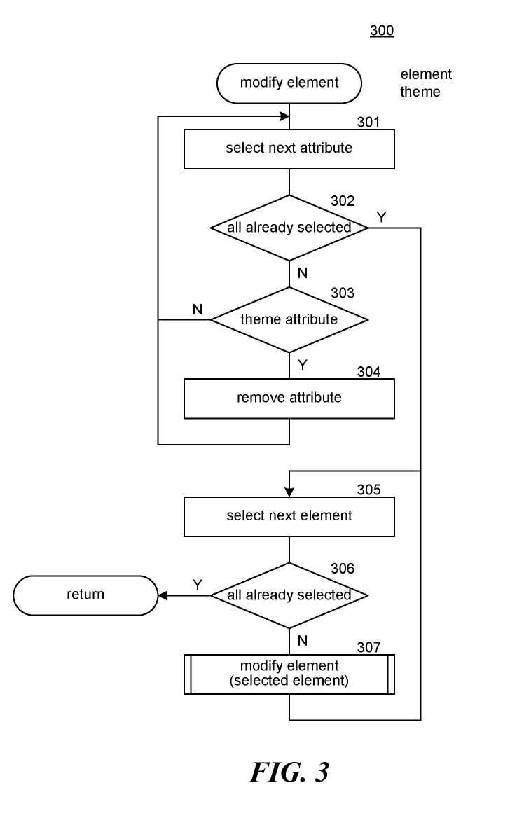

FIG. 3 is a flow diagram that illustrates the processing of a modify element component of the SVG system in some embodiments. A modify element component 300 is passed an indication of an element and a theme and modifies the element to adhere to the theme. This illustrated modify element component performs straightforward modification of elements by removing theme attributes from the elements. A modify element component may perform much more complex modifications such as adding class attributes to access sub-themes. In some embodiments, the component may also interact with a user to perform user-specified modifications or suppression of modifications. The component may simply display an element and allow a user to perform any modification that is consistent with CSS. In blocks 301-304, the component loops adhering the attributes of the element to the theme. In block 301, the component selects the next attribute of the element. For example, the attributes of an svg element may include the height and width of the svg element. The attributes of a circle element include the location of the center and the radius of the circle. In decision block 302, if all the attributes have already been selected, then the component continues at block 305, else the component continues at block 303. In decision block 303, if the selected attribute is a theme attribute specified by the theme, then the component continues at block 304, else the component loops to block 301 to select the next attribute of the element. In block 304, the component removes the attribute from the element so that that attribute will be inherited from the theme and then loops to block 301 to select the next attribute. In blocks 305-307, the component loops processing each element within the passed element. For example, the rectangle element and the circle element of Example 5 are within the svg element. In block 305, the component selects the next element within the passed element. In decision block 306, if all the elements have already been selected, then the component returns, else the component continues at block 307. In block 307, the component invokes the modify element component passing the selected element and then loops to block 305 to select the next element.

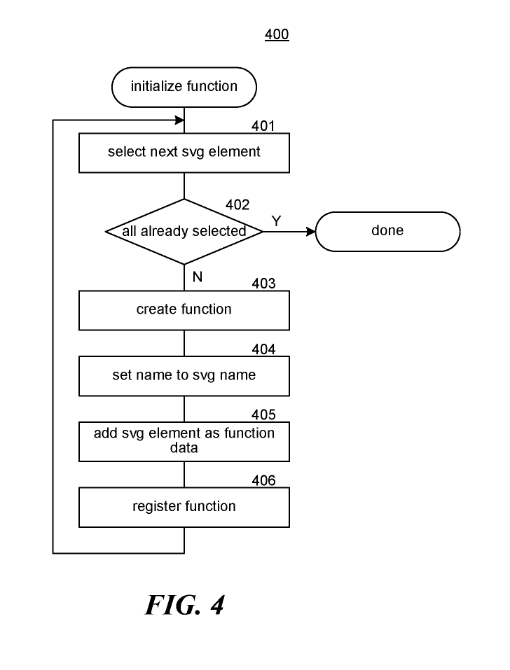

FIG. 4 is a flow diagram that illustrates the processing of an initialize function of the SVG system in some embodiments. An initialize function 400 is a component that is included in an SVG bundle and invoked by a browser to initialize the SVG bundle. In block 401, the component selects the next svg element of the SVG bundle. In decision block 402, if all the svg elements of the SVG bundle have already been selected, then the component completes, else the component continues at block 403. In block 403, the component creates a function for the selected svg element. In block 404, the component sets the name of the created function to the SVG name of the selected svg element. In block 405, the component adds the selected SVG element as the data that the function is to insert into the web page when invoked. In block 406, the component registers the function with the browser and then loops to block 401 to select the next svg element.

The following paragraphs describe various embodiments of aspects of the casting control system. An implementation of the SVG system may employ any combination of the embodiments. The processing described below may be performed by a computing device with a processor that executes computer-executable instructions stored on a computer-readable storage medium that implements the casting control system.

In some embodiments, a method performed by a computing system is provided. The method accesses accessing scalable vector graphic (“SVG”) definitions and theme attributes of a theme. For each SVG definition, the method retrieves the SVG definition and establishes a name for the SVG definition. For each SVG definition, the method modifies the SVG definition to use values for the theme attributes as specified by the theme and stores the SVG definition and the established name in an SVG bundle. In some embodiments, the method further stores an initialize function in the SVG bundle for execution when the SVG bundle is accessed by a web page. In some embodiments, the initialize function, for each SVG definition, generates a function with a function name based on the name of the SVG definition. The generated function is for inserting the SVG definition into a web page at a location from which the function was invoked. In some embodiments, the theme is specified using a style element specified based on Cascading Style Sheets (“CSS”) with a selector for an svg element. In some embodiments, the style element specifies multiple classes for different sub-themes within the theme. In some embodiments, the modifying of the SVG definition includes adding a class attribute to the SVG definition to specify a sub-theme. In some embodiments, the modifying of the SVG definition includes removing from the SVG definition attributes with corresponding theme attributes. In some embodiments, when an attribute is an invariant, the attribute of the SVG definition is not removed even though there is a corresponding theme attribute. In some embodiments, the method further cleans each SVG definition to remove unwanted content from the SVG definition.

In some embodiments, a method performed by a computing system is provided. The method receives a web page that includes a specification of theme attributes of a theme and a reference to a scalable vector graphic (“SVG”) definition in an SVG bundle. When rendering the web page, the method accesses the SVG bundle. The method then executes an initialize function specified by the SVG bundle. The initialize function, for each SVG definition in the SVG bundle, generates a function for inserting the SVG definition into the web page at a location of the reference to the SVG definition. When encountering the reference to the SVG definition, the method executes the generated function for the SVG definition to insert the SVG definition at the location of the reference to the SVG definition. The method then processes the SVG definition based on values of the theme attributes to generate a graphic for the web page. In some embodiments, the method further downloads the SVG bundle from a bundler server. In some embodiments, the theme is specified by a style element with a selector for an svg element. In some embodiments, the style element specifies multiple classes for different sub-themes within the theme. In some embodiments, the SVG definition includes a class attribute for a sub-theme. In some embodiments, the SVG definition includes an attribute that is an invariant so that a value of the attribute of the SVG definition overrides a value of a corresponding theme attribute. In some embodiments, the reference to the SVG definition is specified as an attribute of a division element of the web page. In some embodiments, the SVG definition is specified using an svg element.

In some embodiments, a computing system that includes a computer-readable storage medium storing computer-executable instructions and a process for executing the computer-executable instructions. When the computer-executable instructions are executed, the computing system accesses scalable vector graphic (“svg”) elements and theme attributes specified by a theme. For each svg element, the computing system establishes a name for the svg element, modifies the svg element to use values for the theme attributes, and stores the modified svg element and the established name in an SVG bundle. In some embodiments, the computer-executable instructions that when executed by the computing system further store an initialize function in the SVG bundle for execution when an svg element of the SVG bundle is referenced by a web page. In some embodiments, the initialize function, for each svg element, generates a function with a function name based on the name of the svg element. The generated function is for inserting the svg element into a web page at a location at which the svg element is referenced.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing system, the method comprising:
accessing scalable vector graphic (“SVG”) definitions;
accessing theme attributes of a theme; and
for each SVG definition,
retrieving the SVG definition;
establishing a name for the SVG definition;
modifying the SVG definition to use values for the theme attributes as specified by the theme; and
storing the SVG definition and the established name in an SVG bundle.

2. The method of claim 1 further comprising storing an initialize function in the SVG bundle for execution when the SVG bundle is accessed by a web page.

3. The method of claim 2 wherein the initialize function, for each SVG definition, generates a function with a function name based on the name of the SVG definition, the generated function for inserting the SVG definition into a web page at a location from which the function was invoked.

4. The method of claim 1 wherein the theme is specified using a style element specified based on Cascading Style Sheets (“CSS”) with a selector for an svg element.

5. The method of claim 4 wherein the style element specifies multiple classes for different sub-themes within the theme.

6. The method of claim 5 wherein the modifying of the SVG definition includes adding a class attribute to the SVG definition to specify a sub-theme.

7. The method of claim 1 wherein the modifying of the SVG definition includes removing from the SVG definition attributes with corresponding theme attributes.

8. The method of claim 7 wherein when an attribute is an invariant, the attribute of the SVG definition is not removed even though there is a corresponding theme attribute.

9. The method of claim 1 further comprising cleaning each SVG definition to remove unwanted content from the SVG definition.

10. A method performed by a computing system, the method comprising:
receiving a web page that includes a specification of theme attributes of a theme and a reference to a scalable vector graphic (“SVG”) definition in an SVG bundle; and
when rendering the web page,
accessing the SVG bundle;
executing an initialize function specified by the SVG bundle to, for each SVG definition in the SVG bundle, generate a function for inserting the SVG definition into the web page at a location of the reference to the SVG definition;
when encountering the reference to the SVG definition, executing the generated function for the SVG definition to insert the SVG definition at the location of the reference to the SVG definition; and
processing the SVG definition based on values of the theme attributes to generate a graphic for the web page.

11. The method of claim 10 further comprising downloading the SVG bundle from a bundler server.

12. The method of claim 10 wherein the theme is specified by a style element with a selector for an svg element.

13. The method of claim 12 wherein the style element specifies multiple classes for different sub-themes within the theme.

14. The method of claim 13 wherein the SVG definition includes a class attribute for a sub-theme.

15. The method of claim 10 wherein the SVG definition includes an attribute that is an invariant so that a value of the attribute of the SVG definition overrides a value of a corresponding theme attribute.

16. The method of claim 10 wherein the reference to the SVG definition is specified as an attribute of a division element of the web page.

17. The method of claim 10 wherein the SVG definition is specified using an svg element.

18. A computing system comprising:
a computer-readable storage medium storing computer-executable instructions that when executed by the computing system:
access scalable vector graphic (“svg”) elements;
access theme attributes specified by a theme; and
for each svg element,
establish a name for the svg element;
modify the svg element to use values for the theme attributes; and
store the modified svg element and the established name in an SVG bundle.

19. The computing system of claim 18 wherein the computer-executable instructions that when executed by the computing system further store an initialize function in the SVG bundle for execution when an svg element of the SVG bundle is referenced by a web page.

20. The computing system of claim 19 wherein the initialize function, for each svg element, generates a function with a function name based on the name of the svg element, the generated function for inserting the svg element into a web page at a location at which the svg element is referenced.
